(19) United States
(12) Patent Application Publication
(10) Pub. No.: US 2019/0367251 A1
(43) Pub. Date: Dec. 5, 2019

(54) GAS-SEALED BAG

(71) Applicant: KUNSHAN AIRBAG PACKING CORP, Suzhou (CN)

(72) Inventors: Kao-Hsiung LIAO, Suzhou (CN); Ping-Yuan LIAO, Suzhou (CN)

(73) Assignee: KUNSHAN AIRBAG PACKING CORP, Suzhou (CN)

(21) Appl. No.: 16/148,598

(22) Filed: Oct. 1, 2018

(30) Foreign Application Priority Data
May 30, 2018 (TW) 107118587

(51) Int. Cl. B65D 81/38; B29C 65/02; B65B 61/02; B65B 61/12

(52) U.S. Cl. CPC B65D 81/3893; B29C 65/02; B65D 81/03; B65B 61/12; B65B 61/02

(57) ABSTRACT

A gas-sealed bag is formed by two outer films and two inner films. The gas-sealed bag includes a first transversal heat-seal line, a heat-resistant area, a second transversal heat-seal line, gas inlets, and longitudinal heat-seal lines. The second transversal heat-seal line includes protrusions and bottoms. The protrusions are in the heat-resistant area, and the bottoms are out of the heat-resistant area. The transversal heat-seal lines form an inflation channel, and one end of the inflation channel includes an inflation port. The gas inlets are formed at positions coating a heat-resistant material and corresponding to the protrusions. A gas storage chamber is formed between each two adjacent longitudinal heat-seal lines. Accordingly, additional heat-seal nodes are not necessary to be provided on outer sides of the inner films and inner sides of the outer films for facilitating the inflation port to open. Therefore, manufacturing steps for the gas-sealed bag can be reduced.

### CROSS-REFERENCE TO RELATED APPLICATION

This non-provisional application claims priority under 35 U.S.C. § 119(a) to Patent Application No. 107118587 filed in Taiwan, R.O.C. on May 30, 2018, the entire contents of which are hereby incorporated by reference.

### BACKGROUND

### Technical Field

The instant disclosure relates to a gas-sealed bag, in particular, to a gas-sealed bag with reduced manufacturing steps.

### Related Art

Along with the developments of societies, logistics transportation becomes popular, and consumers are concerned about goods packaging and protection. Recently, a gas-sealed bag known to the inventor is developed. The gas-sealed bag includes a plurality of gas storage chambers and can provide proper shockproof and protection functions. Therefore, the gas-sealed bag is popular and thus a demand for mass production of the gas-sealed bag is generated.

Normally, the aforementioned gas-sealed bag is formed by three or four films. When the gas-sealed bag is inflated, the inflation ports of the gas storage chambers need to be expanded to facilitate the entering of gas. Therefore, heat-seal nodes are provided on the outer sides of the inner films and the inner sides of the outer films at the positions coating a heat-resistant material, and the outer sides of the inner films are adhered with the inner sides of the outer films. Accordingly, when the gas-sealed bag is to be inflated, the inflation port can be expanded properly for gas injection.

### SUMMARY

However, the heat-seal nodes are provided on the bag by machines. As a result, during the procedure, production errors may occur due to the tolerance of manufactory. For example, if the heat-seal nodes are provided at the positions of a non-heat-resistant material, gas will be incapable of entering into the gas storage chamber, and the gas-sealed bag cannot be repaired in such condition. Consequently, the gas-sealed bag is functionally failed and cannot be used.

One embodiment of the instant disclosure provides a gas-sealed bag formed by two outer films and two inner films. The gas-sealed bag further comprises a first transversal heat-seal line, a heat-resistant area, a second transversal heat-seal line, a plurality of gas inlets, and a plurality of longitudinal heat-seal lines.

The inner films are between the outer films, and the length of each of the inner films is shorter than the length of each of the outer films. The first transversal heat-seal line is heat sealed on the outer films to adhere the outer films with the inner films. The heat-resistant area is on an inner surface of one of the inner films, and the inner surface of the inner film facing an inner surface of the other inner film. The heat-resistant area is coated with a heat-resistant material. The second transversal heat-seal line is not intersected with the first transversal heat-seal line. The second transversal heat-seal line comprises a plurality of protrusions and a plurality of bottoms. The protrusions are sequentially connected to the bottoms in series. The protrusions are in the heat-resistant area, and the bottoms are out of the heat-resistant area. The second transversal heat-seal line and the first transversal heat-seal line form an inflation channel One end of the inflation channel comprises an inflation port. The gas inlets are formed at positions coating the heat-resistant material and corresponding to the protrusions. The longitudinal heat-seal lines are separately disposed on the outer films and intersected with the second transversal heat-seal line. A gas storage chamber is formed between each two adjacent longitudinal heat-seal lines.

In one embodiment of the aforementioned gas-sealed bag, each of the protrusions is an arch structure and each of the bottoms is connected to adjacent arch structures.

In one embodiment of the aforementioned gas-sealed bag, each of the protrusions is a peak structure and each of the bottoms is a valley structure.

In one embodiment of the aforementioned gas-sealed bag, the second transversal heat-seal line further comprises a plurality of connecting portions aligned transversally. The connecting portions are above the respective bottoms, and each of the connecting portions is sequentially connected to tops of adjacent protrusions.

In one embodiment of the aforementioned gas-sealed bag, the heat-resistant material is coated on the heat-resistant area in a continuous coating manner.

In one embodiment of the aforementioned gas-sealed bag, the heat-resistant material is coated on the heat-resistant are in a discontinuous coating manner.

In one embodiment of the aforementioned gas-sealed bag, the coating area of the heat-resistant material shields a portion of each of the protrusions.

In one embodiment of the aforementioned gas-sealed bag, top edge lines of the inner films are flush with top edge lines of the outer films, heights of the inner films are equal to heights of the outer films, and the inflation channel is formed between the inner films.

In one embodiment of the aforementioned gas-sealed bag, the top edge lines of the inner films are lower than the top edge lines of the outer films, and the top edge lines of the inner films are between the first transversal heat-seal line and the second transversal heat-seal line.

In one embodiment of the aforementioned gas-sealed bag, the bag further comprises a tear line on one of the longitudinal heat-seal lines.

In one embodiment of the aforementioned gas-sealed bag, the bag further comprises a plurality of heat-seal portions each adhered to the inner films and one of the outer films in the corresponding gas storage chambers, wherein each of the heat-seal portions comprises at least one selected from a group consisting of a heat-seal point, a heat-seal line, and a heat-seal block.

Based on at least one of the aforementioned embodiments, the area of the heat-resistant material shields at least a portion of each of the protrusions to form the gas inlets. When the gas-sealed bag is inflating, portions of the inflation channel other than the bottoms are expanded to open the gas inlets for inflating gas into the gas storage chamber. Therefore, the outer films and the inner films can be heat sealed through the first transversal heat-seal line and the second transversal heat-seal line in one time process. Accordingly, additional heat-seal nodes are not necessary to be provided on the outer sides of the inner films and the inner sides of the outer films in the inflation port for facilitating the inflation port to be opened. Therefore, manufacturing steps for the gas-sealed bag can be reduced.

### BRIEF DESCRIPTION OF THE DRAWINGS

The disclosure will become more fully understood from the detailed description given herein below for illustration only, and thus not limitative of the disclosure, wherein:

FIG. 1A illustrates a partial schematic view of a gas-sealed bag according to one embodiment of the instant disclosure;

FIG. 1B illustrates a partial schematic view of a gas-sealed bag according to one embodiment of the instant disclosure;

FIG. 2 illustrates a partial schematic view of a gas-sealed bag according to one embodiment of the instant disclosure;

FIG. 3 illustrates a partial schematic view of a gas-sealed bag according to one embodiment of the instant disclosure;

FIG. 4 illustrates a partial schematic view of a gas-sealed bag according to one embodiment of the instant disclosure;

FIG. 5 illustrates a partial schematic view of a gas-sealed bag according to one embodiment of the instant disclosure;

FIG. 6A illustrates a partial schematic view of a gas-sealed bag according to one embodiment of the instant disclosure; and

FIG. 6B illustrates a partial schematic view of a gas-sealed bag according to one embodiment of the instant disclosure.

### DETAILED DESCRIPTION

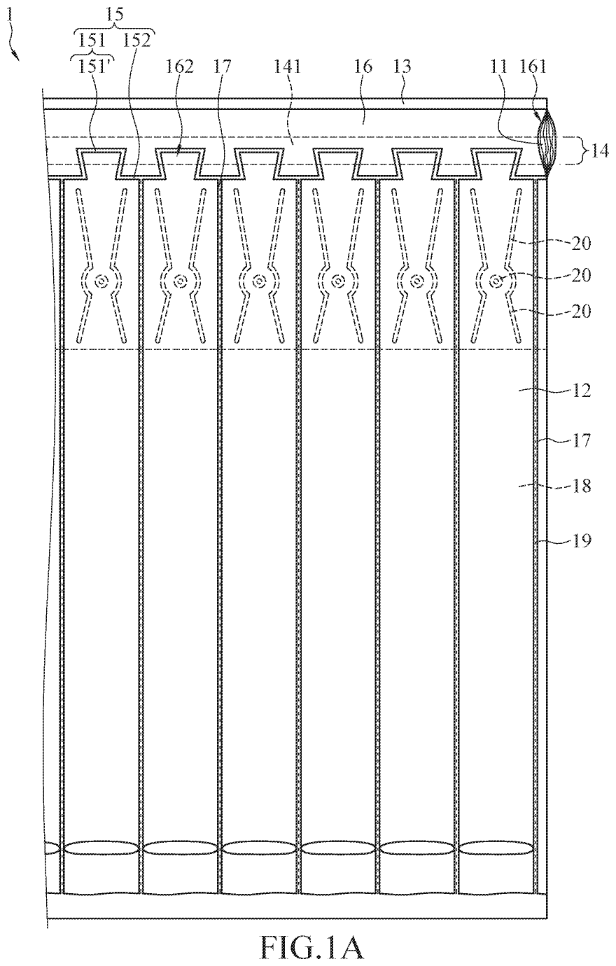

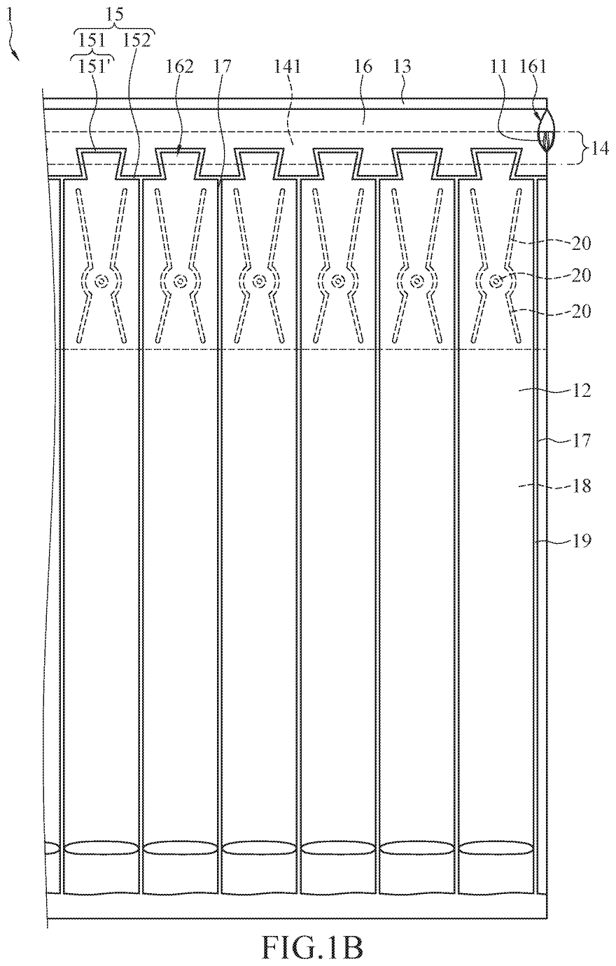

Please refer to FIGS. 1A to 5, respectively illustrating a partial schematic view of a gas-sealed bag 1 according embodiments of the instant disclosure. The gas-sealed bag 1 is formed by two outer films 12 and two inner films 11, and the gas-sealed bag 1 further comprises a first transversal heat-seal line 13, a heat-resistant area 14, a second transversal heat-seal line 15, a plurality of gas inlets 162, and a plurality of longitudinal heat-seal lines 17.

The inner films 11 are between the outer films 12, and a length of each of the inner films 11 is shorter than a length of each of the outer films 12. The first transversal heat-seal line 13 is heat sealed on the outer films 12 to adhere the outer films 12 with the inner films 11. The heat-resistant area 14 is on an inner surface of one of the inner films 11, and the inner surface of the inner film 11 faces an inner surface of the other inner film 11. That is, an area is defined, and a heat-resistant material 141 is coated in the area. Therefore, during the heat-sealing procedure, the inner films 11 are not adhered with each other at positions coating the heat-resistant material 141. In one embodiment, the heat-resistant material 141 is an ink.

The second transversal heat-seal line 15 is not intersected with the first transversal heat-seal line 13. The second transversal heat-seal line 13 and the first transversal heat-seal line 15 form an inflation channel 16. One end of the inflation channel 16 comprises an inflation port 161. Hence, a user can inject gas into the gas-sealed bag 1 through the inflation port 161.

The second transversal heat-seal line 15 comprises a plurality of protrusions 151 and a plurality of bottoms 152. The protrusions 151 are sequentially connected to the bottoms 152 in series, as shown in FIG. 1A. The protrusions 151 are in the heat-resistant area 14, and the bottoms 152 are out of the heat-resistant area 14. The gas inlets 162 are formed at positions coating the heat-resistant material 141 and corresponding to the protrusions 151.

The longitudinal heat-seal lines 17 are separately disposed on the outer films 12 and intersected with the second transversal heat-seal line 15. A gas storage chamber 18 is formed between each two adjacent longitudinal heat-seal lines 17. The gas is injected into each of the gas storage chambers 18 through the corresponding gas inlet 162. Since the inner films 11 and the outer films 12 are adhered by the bottoms 152, the gas storage chambers 18 are inflated to be gas column structures.

As the embodiment(s) shown in FIGS. 1A and 1B, at the positions where the heat-resistant material 141 corresponds to (shields) the protrusions 151, the inner films 11 are not adhered with each other. When the gas-sealed bag 1 is inflating, the bottoms 152 at one side of the inflation channel 16 are sealed to allow the inflation channel 16 to be inflated, and the inflation channel 16 then expands the two inner films 11 to form the gas inlets 162 for gas injection. In other words, at the positions where the heat-resistant material 141 corresponds to the protrusions 151, the inner films 11 are not adhered with each other. Therefore, these positions are provided as the gas inlets 162 for allowing gas to enter into the gas storage chambers 18. Accordingly, heat-seal nodes are not necessary to be provided on the outer sides of the inner films 11 and the inner sides of the outer films 12 at the positions coating the heat-resistant material 141 for facilitating the inflation port 161 to be opened. Consequently, problems that the heat-seal nodes cannot be provided on proper positions due to the production errors can be improved. Furthermore, the manufacturing steps for the gas-sealed bag 1 can be reduced.

Please refer to FIGS. 1A to 3. In these embodiments, each of the protrusions 151 is an arch structure 151′, like a reversed U-shape with corners. In some embodiments, the protrusions 151 are reverse U-shaped, the bottoms 152 are linear or of a U-shape with corners, and each of the bottoms 152 is connected to adjacent arch structures 151′.

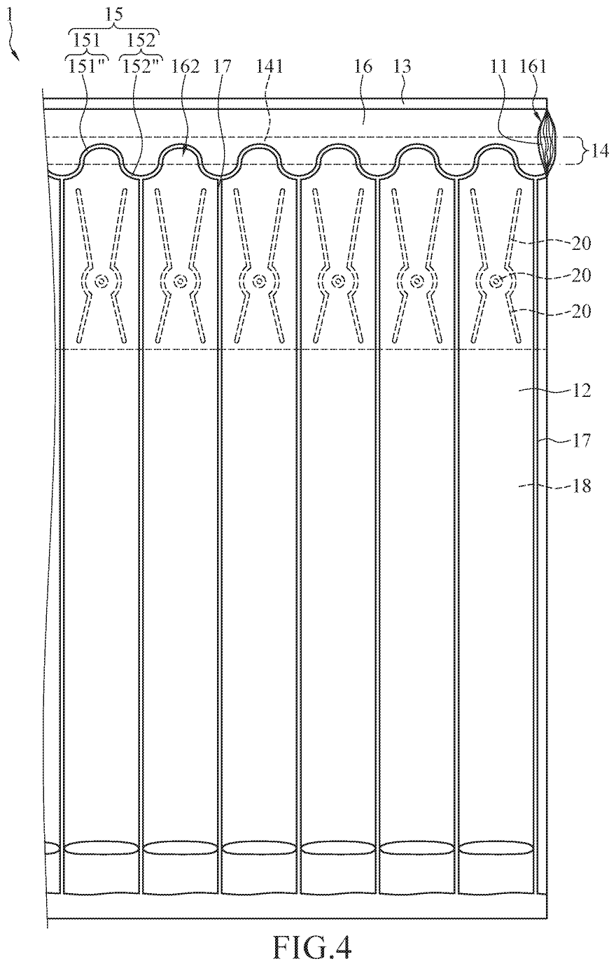

However, embodiments are not limited thereto. In one embodiment, each of the protrusions 151 is a peak structure 151″ and each of the bottoms 152 is a valley structure 152″. As the embodiment shown in FIG. 4, the peak structure 151″ and the valley structure 152″ are reverse U-shaped and U-shaped, respectively. In one embodiment, the peak structure 151″ and the valley structure 152″ are reverse V-shaped and V-shaped, respectively. In one embodiment, the peak structure 151″ and the valley structure 152″ are reverse U-shaped and V-shaped, respectively.

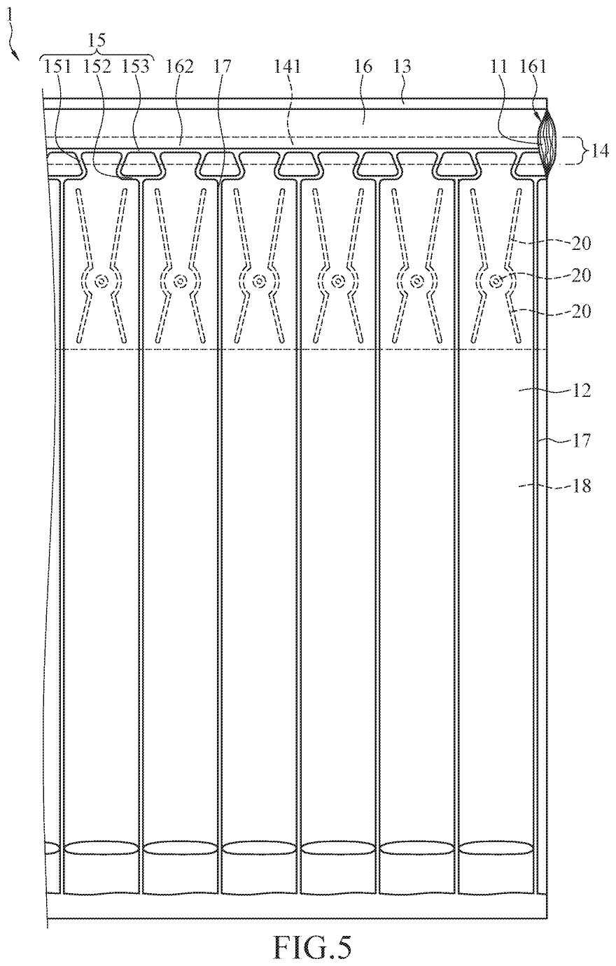

In other words, combinations of aforementioned configurations of the protrusions 151 and the bottoms 152 are possible, and embodiments are not limited thereto. Please refer to FIGS. 5. In this embodiment, the gas-sealed bag 1 further comprises a plurality of connecting portions 153 aligned transversally. The connecting portions 153 are above the respective bottoms 152, and each of the connecting portions 153 is sequentially connected to tops of adjacent protrusions 151. Accordingly, the gas-seal bag 1 in this embodiment can also achieve the omission of heat-seal nodes and reduce the manufacturing steps.

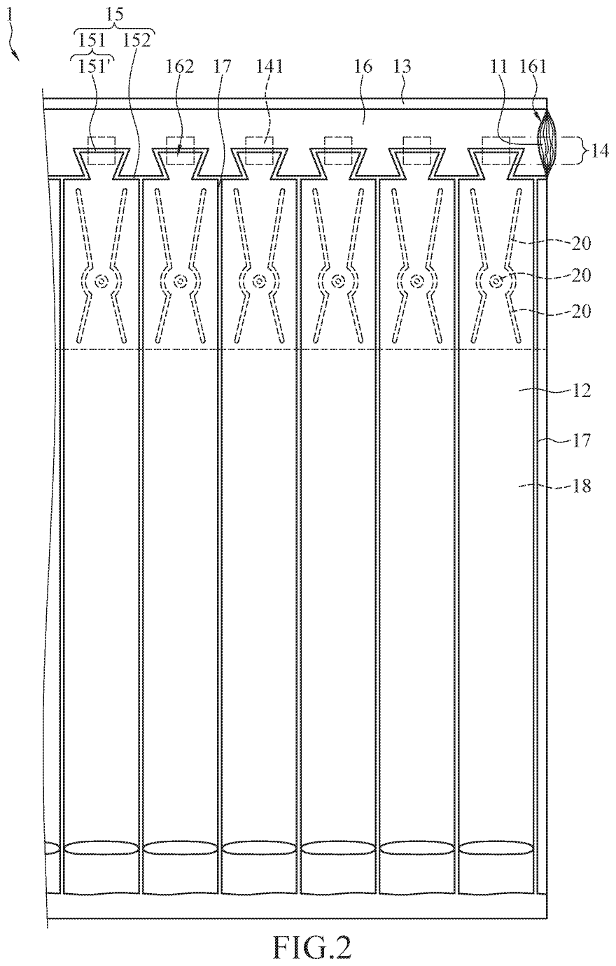

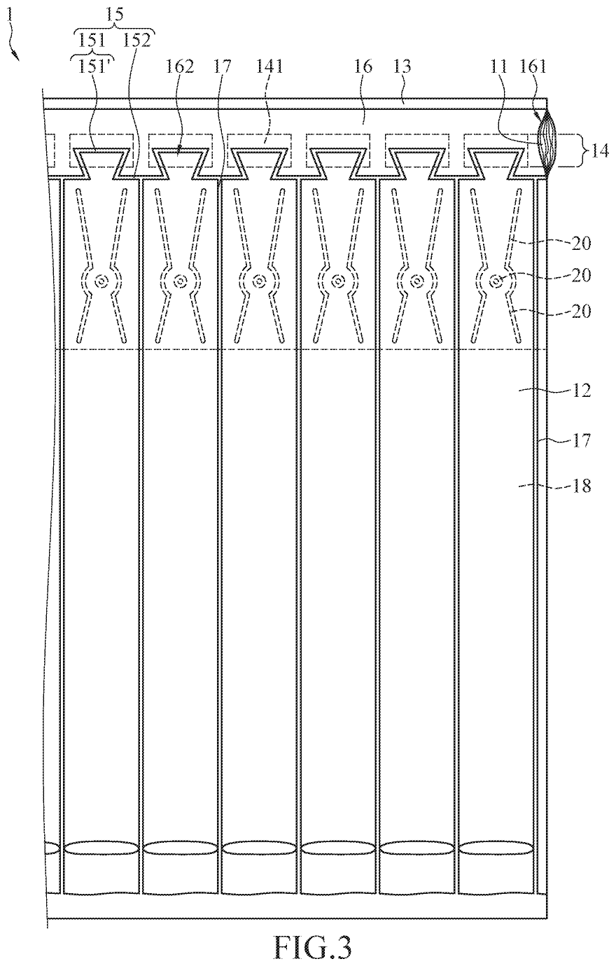

As shown in FIGS. 1, 4, and 5. In these embodiments, the heat-resistant material 141 is coated on the heat-resistant area 14 in a continuous coating manner. Conversely, as shown in FIGS. 2 and 3, in these embodiments, the heat-resistant material 141 is coated on the heat-resistant area 14 in a discontinuous coating manner. However, embodiments are not limited thereto. Structures of the second transversal heat-seal line 15 and the coating manner of the heat-resistant material 141 can be determined according to manufacturers' requirements. As mentioned, the gas inlets 162 are at the positions where the heat-resistant material 141 shields the protrusions 151. Hence, the manufacturers can determine the size of the inflation port 161 by changing the coating area of the heat-resistant material 141. For instance, the inflation port 161 shown in FIG. 2 is smaller than the inflation port 161 shown in FIG. 3. As the embodiment shown in FIG. 3, gas can enter into the gas storage chambers 18 from several orientations while as the embodiment shown in FIG. 2, gas can enter into the gas storage chambers 18 from limited orientations. Again, the area of the coating of the heat-resistant material 141 can be determined according to manufacturers' requirements.

Please refer to FIG. 1A again. The gas-sealed bag 1 further comprises a tear line 19 on one of the longitudinal heat-seal lines 17. Accordingly, based on the required size of the gas-sealed bag 1, the manufacturers can cut or tear from the gas-sealed bag 1 into several sets along the tear line 19 before the inflation or after the inflation.

Furthermore, as in the embodiment shown in FIG. 1A, top edge lines of the inner films 11 are flush with top edge lines of the outer films 12, heights of the inner films 11 are equal to heights of the outer films 12, and the inflation channel 16 is formed between the inner films 11. Conversely, as in the embodiment shown in FIG. 1B, the top edge lines of the inner films 11 are lower than the top edge lines of the outer films 12, and the heat-resistant area 14 is at the top portions of the inner films 11. In other words, the top edge lines of the inner films 11 are between the first transversal heat-seal line 13 and the second transversal heat-seal line 15.

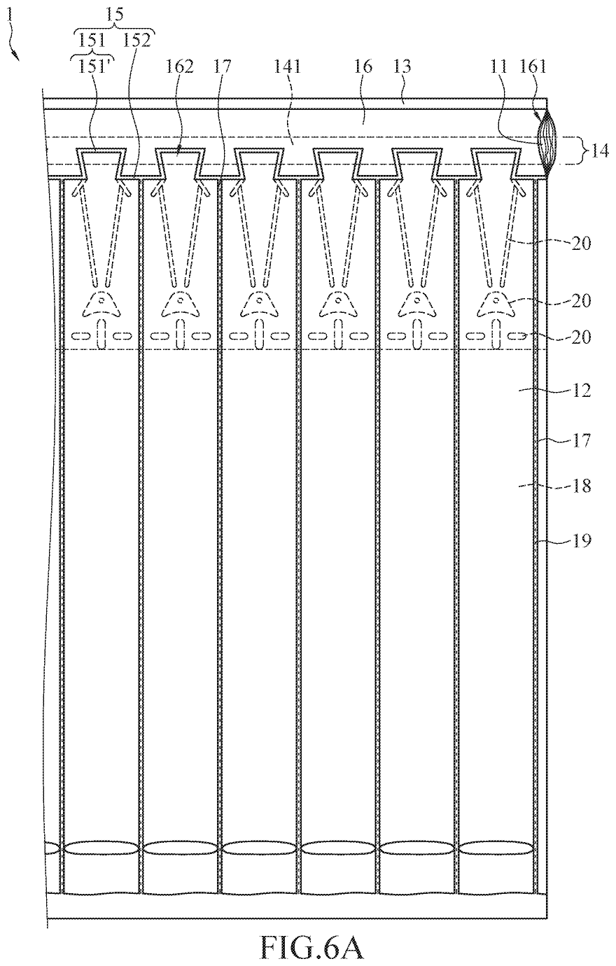

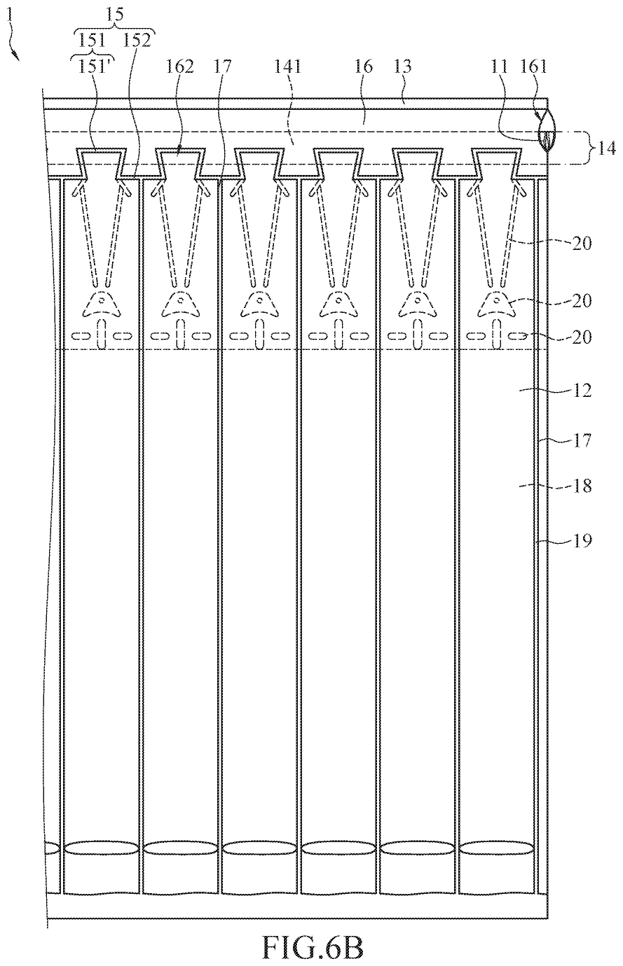

Please refer to FIGS. 1A to 5 as well as FIGS. 6A and 6B. FIGS. 6A and 6B respectively illustrate partial schematic views of a gas-sealed bag 1 according to embodiments of the instant disclosure. In these embodiments, the gas-sealed bag 1 further comprises a plurality of heat-seal portions 20. Each of the heat-seal portions 20 is adhered to the inner films 11 and one of the outer films 12 in the corresponding gas storage chamber 18. Each of the heat-seal portions 20 comprises at least on selected from a group consisting of a heat-seal point, a heat-seal line, and a heat-seal block. The heat-seal portions 20 are used to adhere the inner films 11 with one of the outer films 12. Therefore, when the gas-sealed bag 1 is inflating, the gas storage chamber 18 is inflating, and the adhered inner films 11 as well as the adhered outer film 12 are attached with each other to close the gas inlets 162. Therefore, gas reflow conditions can be prevented.

Based on at least one of the aforementioned embodiments, the protrusions allow the spaces of the gas storage chambers to be extended to the inflation channel. Therefore, the cushioning effect of the gas-sealed bag can be enhanced.

Furthermore, the area of the heat-resistant material shields at least a portion of each of the protrusions to form the gas inlets, and the size of the gas inlets are determined based on the area of the heat-resistant material shielding the protrusions. When the gas-sealed bag is inflating, portions of the inflation channel other than the bottoms are expanded to open the gas inlets for inflating gas into the gas storage chamber. Therefore, additional heat-seal nodes are not necessary to be provided in the inflation port to adhere the outer sides of the inner films and the inner sides of the outer films with each other. Consequently, problems that the heat-seal nodes are provided on wrong positions to cause the failure of the inflation of the gas-sealed bag can be prevented.

In other words, according to one or some embodiments of the instant disclosure, the outer films and the inner films can be heat sealed through the first transversal heat-seal line and the second transversal heat-seal line in one time process. Therefore, problems of wrong positions of the heat-seal nodes can be improved, and the manufacturing steps for the gas-sealed bag can be reduced.

What is claimed is:

1. A gas-sealed bag formed by two outer films and two inner films, wherein the inner films are between the outer films, and a length of each of the inner films is shorter than a length of each of the outer films, the gas-sealed bag further comprises:
a first transversal heat-seal line heat sealed on the outer films to adhere the outer films with the inner films;
a heat-resistant area on an inner surface of one of the inner films, and the inner surface of the inner film facing an inner surface of the other inner film, wherein the heat-resistant area is coated with a heat-resistant material;
a second transversal heat-seal line not intersected with the first transversal heat-seal line, wherein the second transversal heat-seal line comprises a plurality of protrusions and a plurality of bottoms, the protrusions and the bottoms are sequentially and alternately connected with each other in series, wherein the protrusions are in the heat-resistant area, and the bottoms are out of the heat-resistant area, the second transversal heat-seal line and the first transversal heat-seal line form an inflation channel, one end of the inflation channel comprises an inflation port;
a plurality of gas inlets formed at positions coating the heat-resistant material and corresponding to the protrusions; and
a plurality of longitudinal heat-seal lines separately disposed on the outer films and intersected with the second transversal heat-seal line, wherein a gas storage chamber is formed between each two adjacent longitudinal heat-seal lines.

2. A gas-sealed bag formed by two outer films and two inner films, wherein the inner films are between the outer films, and a length of each of the inner films is shorter than a length of each of the outer films, the gas-sealed bag further comprises:
a first transversal heat-seal line heat sealed on the outer films to adhere the outer films with the inner films;
a heat-resistant area on an inner surface of one of the inner films, and the inner surface of the inner film facing an inner surface of the other inner film, wherein the heat-resistant area is coated with a heat-resistant material;
a second transversal heat-seal line not intersected with the first transversal heat-seal line, wherein the second transversal heat-seal line comprises a plurality of protrusions and a plurality of bottoms, the protrusions are sequentially connected to the bottoms in series, wherein the protrusions are in the heat-resistant area, and the bottoms are out of the heat-resistant area, the second transversal heat-seal line and the first transversal heat-seal line form an inflation channel, one end of the inflation channel comprises an inflation port;
a plurality of gas inlets formed at positions coating the heat-resistant material and corresponding to the protrusions;
a plurality of longitudinal heat-seal lines separately disposed on the outer films and intersected with the second transversal heat-seal line, wherein a gas storage chamber is formed between each two adjacent longitudinal heat-seal lines; and
a plurality of heat-seal portions each adhered to the inner films and one of the outer films in the corresponding gas storage chambers, wherein each of the heat-seal portions comprises at least one selected from a group consisting of a heat-seal point, a heat-seal line, and a heat-seal block.

3. The gas-sealed bag according to claim 1, wherein each of the protrusions is an arch structure and each of the bottoms is connected to adjacent arch structures.

4. The gas-sealed bag according to claim 1, wherein each of the protrusions is a peak structure and each of the bottoms is a valley structure.

5. The gas-sealed bag according to claim 1, wherein the second transversal heat-seal line further comprises a plurality of connecting portions aligned transversally, the connecting portions are above the respective bottoms, and each of the connecting portions is sequentially connected to tops of adjacent protrusions.

6. The gas-sealed bag according to claim 1, wherein the heat-resistant material is coated on the heat-resistant area in a continuous coating manner.

7. The gas-sealed bag according to claim 1, wherein the heat-resistant material is coated on the heat-resistant area in a discontinuous coating manner.

8. The gas-sealed bag according to claim 1, wherein top edge lines of the inner films are flush with top edge lines of the outer films, heights of the inner films are equal to heights of the outer films, and the inflation channel is formed between the inner films.

9. The gas-sealed bag according to claim 1, wherein top edge lines of the inner films are lower than top edge lines of the outer films, and the top edge lines of the inner films are between the first transversal heat-seal line and the second transversal heat-seal line.

10. The gas-sealed bag according to claim 1, further comprising a tear line on one of the longitudinal heat-seal lines.

11. The gas-sealed bag according to claim 2, wherein each of the protrusions is an arch structure and each of the bottoms is connected to adjacent arch structures.

12. The gas-sealed bag according to claim 2, wherein each of the protrusions is a peak structure and each of the bottoms is a valley structure.

13. The gas-sealed bag according to claim 2, wherein the second transversal heat-seal line further comprises a plurality of connecting portions aligned transversally, the connecting portions are above the respective bottoms, and each of the connecting portions is sequentially connected to tops of adjacent protrusions.

14. The gas-sealed bag according to claim 2, wherein the heat-resistant material is coated on the heat-resistant area in a continuous coating manner.

15. The gas-sealed bag according to claim 2, wherein the heat-resistant material is coated on the heat-resistant area in a discontinuous coating manner.

16. The gas-sealed bag according to claim 2, wherein top edge lines of the inner films are flush with top edge lines of the outer films, heights of the inner films are equal to heights of the outer films, and the inflation channel is formed between the inner films.

17. The gas-sealed bag according to claim 2, wherein top edge lines of the inner films are lower than top edge lines of the outer films, and the top edge lines of the inner films are between the first transversal heat-seal line and the second transversal heat-seal line.

18. The gas-sealed bag according to claim 2, further comprising a tear line on one of the longitudinal heat-seal lines.
